(19) United States
(12) Patent Application Publication
(10) Pub. No.: US 2005/0144559 A1
(43) Pub. Date: Jun. 30, 2005

(54) Method and system to selectively print a file

(76) Inventor: Hyun-chul Kim, Suwon-si (KR)

Correspondence Address: STANZIONE & KIM, LLP, 1740 N STREET, N.W., FIRST FLOOR, WASHINGTON, DC, 20036, US

(21) Appl. No.: 11/020,126

(22) Filed: Dec. 27, 2004

(30) Foreign Application Priority Data
Dec. 26, 2003 (KR) 2003-97804

(51) Int. Cl. G06F 17/21

(52) U.S. Cl. 715/530

(57) ABSTRACT

A printing system to selectively print a file includes a storage to store an input file, page information extracted from the input file, and a file edited by pages, an operating panel equipment to display the page information by pages to allow the input file stored in the storage to be selectively edited and editing the input file by pages, a control unit to store the input file, the page information and the edited file in the storage and performing control commands inputted through the operating panel equipment, and a printer to convert the edited file into printable data and printing the printable data.

### CROSS-REFERENCE TO RELATED APPLICATIONS

This application claims the priority of Korean Patent Application No. 2003-97804, filed on Dec. 26, 2003, in the Korean Intellectual Property Office, the disclosure of which is incorporated herein in its entirety and by reference.

### BACKGROUND OF THE INVENTION

1. Field of the Invention

The present general inventive concept relates to a method and system to selectively print a file after editing a specific region of the file, and more particularly, to a method and system to selectively print a file, which transmits a file from a terminal to a printer, displays and edits the file by pages, and prints the edited files.

2. Description of the Related Art

FIG. 1 shows a flowchart illustrating a conventional method of selectively printing a specific region of a file.

As shown in the flowchart of FIG. 1, the conventional method comprises an application program loading step S100, a file opening step S101, an editing step S102, a print instruction performing step S103, and a printing step S104.

In the application program loading step S100, a user loads an application program such as a word processor to print a specific region of a file by editing the file.

In the file opening step S101, the user opens the file to edit the file in the application program.

In the editing step S102, the user edits the opened file. For example, the user deletes an unnecessary region or selects a desire region to print only the desire region of the opened file.

In the print instruction performing step S103, the user designates a printer server, sets an option such as the number of copies and the like, and presses a printing button to print the edited file.

In the printing step S104, the edited file is transmitted to the printer, and the printer converts the edited file into printable data and prints the edited file on a printing paper by driving a laser diode using an on/off method.

In the above-described conventional art, the user can print out the file by pages. That is, the user can designate a desired page to be printed. When the user focuses on only a specific region of a page, the user edits the specific region of the page and prints the specific region. However, this process is a troublesome for the user, and deteriorates the work efficiency.

### SUMMARY OF THE INVENTION

The present general inventive concept provides a method and system, which transmits a file from a terminal to a printer, displays and edits the file by pages, and prints the edited files.

The foregoing and/or other aspects and advantages of the present general inventive concept can be achieved by providing a printing system of selectively printing a file, comprising: a storage to store an input file, page information extracted from the input file, and a file edited by pages; an operating panel equipment to display the page information by pages to allow the input file stored in the storage to be selectively edited and editing the input file by pages; a control unit to store the input file, the page information and the edited file in the storage and perform control commands inputted through the operating panel equipment; and a printer to convert the edited file into printable data and printing the printable data.

Additional aspects and advantages of the present general inventive concept will be set forth in part in the description which follows and, in part, will be obvious from the description, or may be learned by practice of the general inventive concept.

The storage may be one of a hard disk drive and a RAM disk drive.

The operating panel equipment may comprise a touch screen liquid crystal display.

The foregoing and/or other aspects and advantages of the present general inventive concept may also be achieved by providing a method of selectively printing a file, comprising: extracting page information from an input file loaded and storing the extracting page information; selecting a specific region to be printed after displaying the page information and a page selected in accordance with the page information; and printing the selected specific region after converting the selected specific region into printable data.

The method may further comprise displaying the specific region when there is a user's request.

The page information may comprise a page number, the number of lines per page, and the number of words per page.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart illustrating a conventional method for selectively printing a specific region of a file;

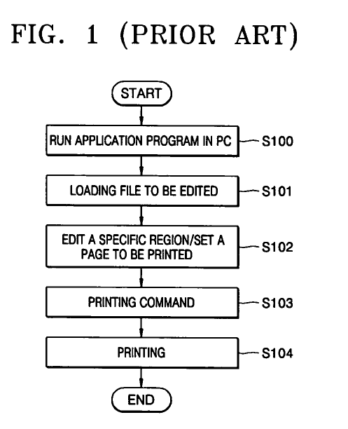

FIG. 2 is a block diagram illustrating a printing system to selectively print a specific region of a file according to an embodiment of the present general inventive concept;

FIG. 3 is a flowchart illustrating a method of selectively printing a specific region of a file according to an embodiment of the present general inventive concept;

FIG. 4 is a flowchart illustrating operation S300 of FIG. 3 in more detail;

FIGS. 5 and 6 are flowcharts illustrating operation S301 of FIG. 3 in more detail; and

FIG. 7 is a view of an LCD of an operating panel equipment according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

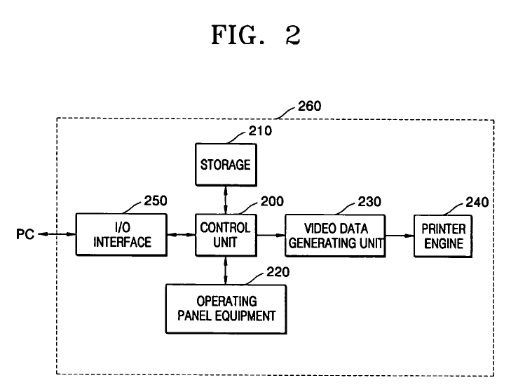

FIG. 2 shows a printing system to selectively print a specific region of a file according to an embodiment of the present general inventive concept.

Referring to FIG. 2, a printing system 260 of this embodiment comprises a control unit 200, a storage 210, an operating panel equipment 220, a video data generating unit 230, a printer engine 240, and an input/output (I/O) interface 250.

The control unit 200 stores an input file transmitted from a computer, page information on each page of the input file, and a file edited by the user based on the page information in the storage 210. The control unit 200 also performs a variety of control commands such as a printing command, an undo command, an editing mode command, and the like that will be inputted through the operating panel equipment by the user.

The storage 210 stores the input file, the page information extracted from the input file, and the file edited by pages in the operating panel equipment 220. The storage 210 may be a hard disk drive or a RAM disk drive. In addition, the storage 210 comprises a first region storing the input file transmitted from the computer, a second region storing the page information extracted by scanning the input file by pages, and a third region storing the edited file.

The operating panel equipment 220 displays the page information and contents of the input file by pages so that the user can edit the input file stored in the storage 210, thereby making it possible to print a specific region of the displayed page, which designated by the user, or to continuously print a plurality of specific regions of the displayed page, which is also designated by the user. The operating panel equipment 220 may employ a touch screen liquid crystal display (LCD) as a display unit.

The video data generating unit 230 receives the file from the control unit 200 and converts the file into printable data. The printable data is transmitted to the printer engine 240.

The printer engine 240 operates a laser scanning unit (not shown) therein using an on/off method to transfer the printable data to a photoconductive drum (not shown) and to print an image on a printing paper through developing and fixing processes.

The I/O interface 250 interfaces the printing system 260 of the embodiment of FIG. 2 with an external device such as the computer.

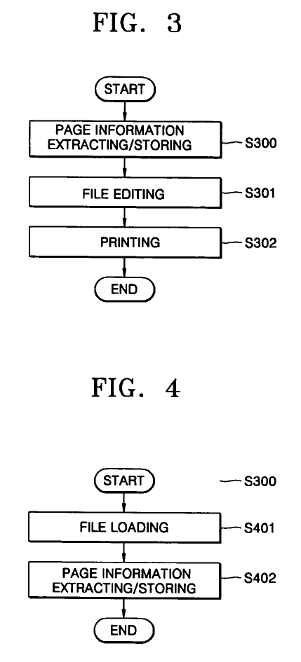

FIG. 3 shows a flow chart illustrating a method of selectively printing a specific region of a file according to an embodiment of the present general inventive concept, comprising a page information extracting/storing operation S300, a file editing operation S301, and a printing operation S302.

Referring to FIG. 3, in the page information extracting/storing operation S300, a file edited in an application program of the computer is received, page information is extracted by scanning the edited file by pages, and the page information is stored. Here, the page information means information on each page of the file transmitted from the computer. The information may include a page number, the number of lines of each page, the number of words of each line, the number of words of each page, and the like.

In the file editing operation S301, a page selected by the user is displayed in accordance with the page information extracted in the page information extracting/storing operation S300, a specific region to be printed is set, and an edited file is made by designating the specific region.

In the printing operation S302, the file to be printed is received from the control unit 200, converted into the printable data, and printed on a printing paper through developing and fixing processes by operating the laser scanning unit in the printer engine 240 using an on/off method and transferring the printable data to the photoconductive drum.

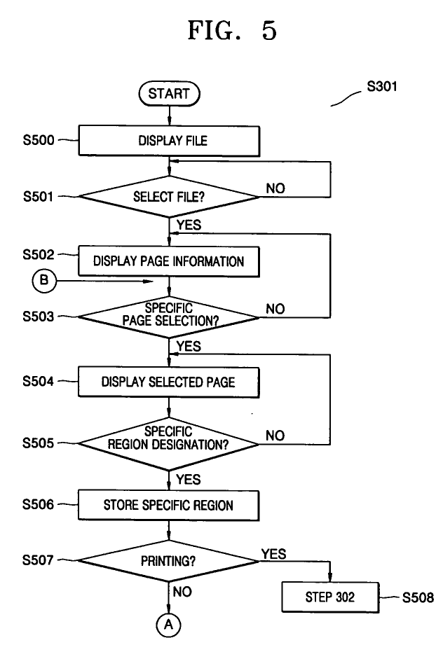

FIG. 4 shows a flow chart illustrating operation S300 of FIG. 3 in more detail. In FIG. 4, operation S300 comprises a file loading operation S401 and a page information extracting/storing operation S402.

In the filing loading operation S401, the input file transmitted from the computer is loaded in a first predetermined region (the first region) of the storage 200.

In the page information extracting/storing operation S402, the input file loaded in the first predetermined region is read to extract the page information, and then the extracted page information is stored in a second predetermined region (the second region) of the storage 210.

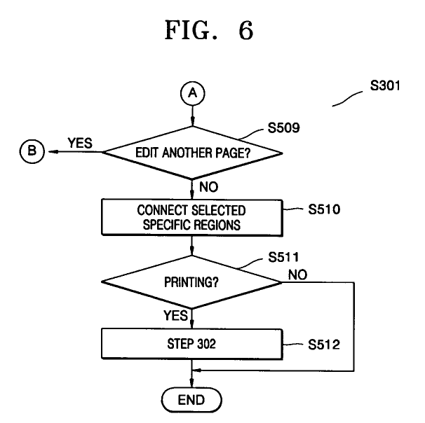

FIGS. 5 and 6 show a flow chart illustrating operation S300 of FIG. 3 in more detail.

Referring to FIGS. 5 and 6, in operation S500, when a user selects an editing mode, the file information on the input file stored in the first predetermined region (the first region) of the storage 210 is displayed. That is, the first predetermined region is divided into a file information storing region and a file contents storing region. Here, the file information may include a file name, a user name, a file size, and the like. That is, the user can read only the file information among a variety of information contained in the storage and quickly identify the file.

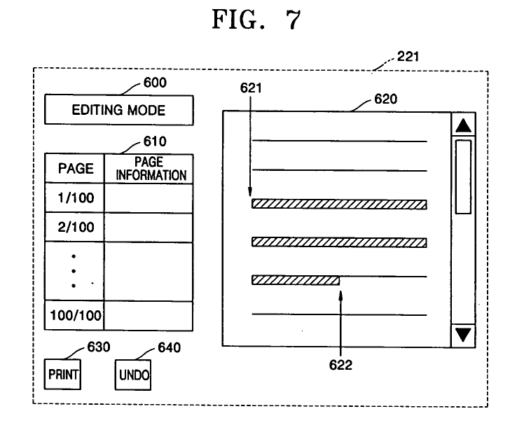

The file information is displayed on the touch screen LCD 221 (see FIG. 7) of the operating panel equipment 220. The user selectively touches a specific file to be edited to enter into the editing mode.

In operation S501, the user selects the specific file to be edited from the file information displayed on the touch screen LCD 221 of the operating panel equipment 220.

In operation S502, when the user selects the specific file, the page information on the selected file is displayed on the touch screen LCD 221 of the operating panel equipment 220 by pages.

In operation S503, the control unit 200 determines if the user selects a specific page based on the displayed page information. When the user does not select the specific page, the process returns to operation S502.

In operation S504, when the user selects the specific page, the contents of the specific page are displayed on a right section of the touch screen LCD 221 of the operating panel equipment 220.

In operation S505, the control unit 200 determines if the user designates a specific region of the specific page displayed on the right section of the touch screen LCD of the operating panel equipment 220. When the user does not designate the specific region, the process returns to operation S504.

In operation S506, the specific region designated by the user is stored in a third predetermined region (the third region) of the storage 210.

In operation S507, it is determined whether the user intends to print the specific region. When the user presses the printing button to print the specific region, the specific region is converted into the printable data in operation S302 and is printed on the printing paper. If required by the user, the specific region may be displayed on the operating panel equipment before printing.

When the user intends to further print a specific region of another page, operation S509 is performed.

In operation S509, it is determined whether the user intends to further print a specific region of another page. When it is determined that the user intends to further print the specific region of another page, the process returns to operation S503 to perform operations S503, S504, S505, and S506.

In operation S510, the controller 200 generates an edited filed formed by connecting the specific regions of the specific pages selected by the user based on location information on the specific regions designated by the user and stores the edited file in the storage.

In operation S511, the controller 200 determines whether the user intends to print.

When it is determined that the user intends to print, the process returns to operation S302 to print the edited file. However, when it is determined that the user intends not to print the edited file, the process is ended.

FIG. 7 shows the touch screen LCD 221 of the operating panel equipment 220 of the present invention. The touch screen LCD 221 comprises a button section 600, a page information display section 610, a print button section 630, an undo button section 640, and a page contents display section 622 to display the contents of the page selected by the user.

FIG. 7 shows an example image displaying an editing mode 600 selected by the user, page information 610 displayed when the file to be edited is selected, and contents 620 of the specific page selected by the user.

The reference numerals 621 and 622 indicate specific regions designated by the user. The specific regions are represented by, for example, an inversed block.

The present general inventive concept can be realized as a method, an apparatus, and a system. When the present general inventive concept is manifested in computer software, components of the present general inventive concept may be replaced with code segments that are necessary to perform the required action. Programs or code segments may be stored in media readable by a processor, and transmitted as computer data that is combined with carrier waves via a transmission media or a communication network.

The media readable by a processor include anything that can store and transmit information, such as, electronic circuits, semiconductor memory devices, ROM, flash memory, EEPROM, floppy discs, optical discs, hard discs, optical fiber, radio frequency (RF) networks, etc. The computer data also includes any data that can be transmitted via an electric network channel, optical fiber, air, electro-magnetic field, RF network, etc.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A printing system to selectively print a file, comprising:
a storage to store an input file, page information extracted from the input file, and a file edited by pages;
an operating panel equipment to display the page information by pages to allow the input file stored in the storage to be selectively edited and to edit the input file by pages;
a control unit to store the input file, the page information and the edited file in the storage and to perform control commands inputted through the operating panel equipment; and
a printer to convert the edited file into printable data and to print the printable data.

2. The printing system of claim 1, wherein the storage is one of a hard disk drive and a RAM disk drive.

3. The printing system of claim 1, wherein the operating panel equipment comprises a touch screen liquid crystal display.

4. The printing system of claim 1, wherein the page information comprises a page number, the number of lines of each page, and the number of words of each page.

5. The printing system of claim 1, wherein the printer comprises a video generating unit that receives the edited file from the control unit and converts the file into the printable data.

6. The printing system of claim 1, wherein the control unit provides a printing command, an undo command, and an editing mode command that is inputted through the operating panel equipment.

7. The printing system of claim 1, wherein the storage comprises a first region to store the input file and a second region to store the page information extracted by scanning the input file by pages, and a third region to store the edited file.

8. The printing system of claim 1, further comprising an I/O interface to interface the printing system with an external device which provides the input file.

9. A printing system to selectively print a file, comprising:
a storage to store an input file, page information extracted from the input file, and a file edited by pages;
an operating panel equipment to display the page information by pages to allow the input file stored in the storage to be selectively edited and to edit the input file by pages;
a control unit to store the input file, the page information and the edited file in the storage and to perform control commands inputted through the operating panel equipment;
a video data generating unit to receive the edited file from the control unit and to convert the file into printable data; and
a printer engine to cause the printable data to be printed.

10. The printing system of claim 9, wherein the page information comprises a page number, the number of lines of each page, and the number of words of each page.

11. A method of selectively printing a file, comprising:
extracting page information from an input file loaded and storing the extracting page information;
selecting a specific region to be printed after displaying the page information and a page selected in accordance with the page information; and
printing the selected specific region after converting the selected specific region into printable data.

12. The method of claim 11, further comprising displaying the specific region when there is a request.

13. The method of claim 11, wherein the page information comprises a page number, the number of lines per page, and the number of words per page.

14. A computer readable storage medium containing a method of selectively printing a file, the method including:
extracting page information from an input file loaded and storing the extracting page information;
selecting a specific region to be printed after displaying the page information and a page selected in accordance with the page information; and
printing the selected specific region after converting the selected specific region into printable data.

15. The computer readable storage medium of claim 14, wherein the method further includes the operation of displaying the specific region when there is user's request.

16. The computer readable storage medium of claim 14, wherein the page information comprises a page number, the number of lines per page, and the number of words per page.
